(19) United States
(12) Patent Application Publication
(10) Pub. No.: US 2003/0035384 A1
(43) Pub. Date: Feb. 20, 2003

(54) Apparatus and method for concealing the loss of audio samples

(75) Inventors: Jonathan Cline, Santa Barbara, CA (US); Chuan Hsueh, Santa Barbara, CA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: Globespan Virata, Incorporated

(21) Appl. No.: 10/138,307

(22) Filed: May 6, 2002

Related U.S. Application Data
(60) Provisional application No. 60/312,347, filed on Aug. 16, 2001.

(51) Int. Cl. H04B 3/20

(52) U.S. Cl. 370/286; 379/226

(57) ABSTRACT

The present invention pertains to an apparatus (and corresponding method) including both an echo cancellation module and packet loss concealment module for the processing of audio samples sent within packet data networks. The echo cancellation module serves the role of reducing echoes that may have been introduced in the audio samples. The packet loss concealment module serves the role of concealing loss of audio samples that may have occurred in the received audio samples. The echo cancellation module includes a buffer for storing recently received audio samples. This buffer provides historical data for use by both the echo cancellation module and the packet loss concealment module in performing their respective functions. The use of one data buffer (instead of separate buffers for the echo cancellation module and the packet loss concealment module) provides a resource-efficient solution, allowing the invention to be implemented in a cost-effective and size-efficient manner.

### CROSS REFERENCE TO RELATED APPLICATIONS

This application claims priority to U.S. Provisional Application No. 60/312,347, filed on Aug. 16, 2001, which is hereby incorporated by reference herein in its entirety.

### FIELD OF THE INVENTION

The present invention generally relates to an apparatus and method for concealing the loss of audio samples sent within packet data networks. In a more specific embodiment, the present invention relates to an apparatus and method for concealing the loss of audio samples sent within packet data networks in a resource-efficient manner.

### BACKGROUND OF THE INVENTION

There has been a growing interest in the transmission of audio information (such as spoken voice) over data packet networks. In this technique, analog audio data is converted into digital data, and this digital data is encapsulated into packets suitable for transmission over a packet network, for example Internet. At the receiving site, the audio information data is extracted and presented to an output media device, such as a conventional telephone.

It may be helpful to consider communications protocols and networks employed to effect data communication among communicating devices. When transmitting and receiving data among two or more devices, such as computers via modems, it is typically necessary to employ a common communications protocol or format, or at least complimentary protocols or formats. A transmitting computer or device supports a protocol, in hardware or in software, that is common or effectively conversive with the protocol supported by the receiving computer or device to effect communication of essentially uncorrupted data. To make data communication effective, protocols determine certain operating characteristics, for example, rate of transmission (in baud or bps), transmission mode, i.e., half-duplex or full-duplex mode, synchronous or asynchronous transmission, the type of error checking to be used, the data compression method, notification by a transmitting device of message termination, and notification by a receiving device that the message was received. There are a number of standard protocols available to designers for selection based on respective advantages and disadvantages and depending upon the system needs.

A protocol system model that has served as a starting reference point for many protocols in use is the Open System Interconnection (OSI) model, which defines a networking framework for implementing protocols in seven layers, commonly referred to as a stack. From lowest to highest the layers are: 1) physical layer, 2) data link layer, 3) network layer, 4) transport layer, 5) session layer, 6) presentation layer, and 7) application layer. Control is passed from one layer to the next, starting at the application layer at a first transmitting device, proceeding to the bottom physical layer, over the channel to the receiving device and back up the layer hierarchy to the application layer. The network layer, for example, may rely on the IP protocol and determine the routing of packets of data from sender to receiver via the data link layer. From the network layer, the transport layer provides a virtual error-free, point-to-point connection so that a transmitting device can send messages to a receiving device and they will arrive un-corrupted and in the correct order. The transport layer establishes and dissolves connections between communicating devices.

Asynchronous Transfer Mode (ATM) is a network technology based on transferring data in cells or packets of a fixed size. The cell used with ATM is relatively small compared to units used with older technologies. The small, constant cell size allows ATM equipment to transmit video, audio, and computer data over the same network, and assure that no single type of data hogs the line. ATM creates a fixed channel, or route, between two points whenever data transfer begins. This differs from TCP/IP, in which messages are divided into packets and each packet can take a different route from source to destination. This difference makes it easier to track and bill data usage across an ATM network, but it makes it less adaptable to sudden surges in network traffic. There are four different types of ATM service: Constant Bit Rate (CBR), Variable Bit Rate (VBR), Unspecified Bit Rate (UBR), and Available Bit Rate (ABR).

Transmission Control Protocol (TCP) over Internet Protocol (IP) (TCP/IP) is the de facto standard Ethernet protocols incorporated into 4.2BSD Unix. TCP/IP was developed by DARPA for internetworking and encompasses both network layer and transport layer protocols. While TCP and IP specify two protocols at specific protocol layers, TCP/IP is often used to refer to the entire DoD protocol suite based upon these, including telnet, FTP, UDP and RDP. TCP enables two communicating devices to establish a connection and exchange streams of data. TCP effects delivery of data and in such a way that packets are delivered in the same order in which they were sent.

User Datagram Protocol (UDP) is a connectionless protocol that, like TCP, runs on top of IP networks. Unlike TCP/IP, UDP/IP provides very few error recovery services, offering instead a direct way to send and receive datagrams over an IP network. It's used primarily for broadcasting messages over a network.

Real-Time Transport Protocol (RTP) is an Internet protocol and provides end-to-end network transport functions suitable for applications transmitting real-time data such as audio, video or simulation data, over multicast or unicast network services. RTP alone does not address resource reservation and does not guarantee quality-of-service for real-time services, but it does provide mechanisms for the sending and receiving applications to support streaming data. Typically, RTP runs on top of the UDP protocol, although the specification is general enough to support other transport protocols. The data transport is augmented by a control protocol (RTCP) to allow monitoring of the data delivery in a manner scalable to large multicast networks, and to provide minimal control and identification functionality. RTP and RTCP are designed to be independent of the underlying transport and network layers. The protocol supports the use of RTP-level translators and mixers.

The transmission of audio data over packet networks (e.g., wireless, cellular, ATM, etc.) enjoys many benefits over its circuit-switched network counterparts, but it also presents unique challenges. Namely, the transmission of audio data over packet networks is subject to occasional packet loss. This manifests itself at the receiving device in an audio output including distracting cracks, pops, and hisses. Some packet network data transmissions do not have data loss by design.

A number of strategies have been developed to address the aforementioned problem. One such solution is described in “Packet Loss Concealment for Use with ITU-T Recommendation G.711,” by American National Standards Institute, Document number T1.521-1999. The solution described therein entails storing audio data in a history buffer. In the event of a loss of packet data, data stored in the history buffer is retrieved and substituted in place of the missing data. For packet loss extended over a prescribed time period, this algorithm attenuates the stored data using a ramp function.

The solution described above is not fully satisfactory. Goals in designing many receivers include minimizing the cost and/or size of the device, and/or improving its processing speed. These requirements may mandate the use of computationally sparse devices to process the audio information. As appreciated by the present inventors, the use of a large buffer to store prior audio packets complicates a receiver design, and therefore works against the goal of providing a sparse computational environment.

Accordingly, there is a need in the art to provide a more effective and resource-efficient apparatus and method for concealing the loss of audio samples sent within packet data networks.

### BRIEF SUMMARY OF THE INVENTION

The disclosed technique solves the above-identified difficulties in known systems, as well as other unspecified deficiencies in the known systems.

According to one exemplary embodiment, the present invention pertains to an apparatus (and corresponding method) including both an echo cancellation module and packet loss concealment module for the processing of audio samples sent within packet data networks. The echo cancellation module serves the role of reducing echoes that may have been introduced in the audio samples. The packet loss concealment module serves the role of concealing the loss of audio samples that may have occurred in the received audio samples. The echo cancellation module includes a buffer for storing recently received audio samples. This buffer provides historical data for use by both the echo cancellation module and the packet loss concealment module in performing their respective functions. The use of one data buffer (instead of separate buffers for the echo cancellation module and the packet loss concealment module) provides a resource-efficient solution, allowing the invention to be implemented in a cost-effective and size-efficient manner.

Still further features and advantages of the present invention are identified in the ensuing description, with reference to the drawings identified below.

### BRIEF DESCRIPTION OF THE DRAWINGS

FIG. 1 shows an exemplary system for implementing the invention.

FIG. 2 shows a logical depiction of an exemplary echo canceling module for use in the system of FIG. 1.

FIG. 3 shows a logical depiction of an exemplary packet loss concealment module (PLC) for use in the system of FIG. 1.

FIG. 4 shows an exemplary algorithm for concealing the loss of packets in the system of FIG. 1.

FIG. 5 shows PLC output with single tone input for a short period of data loss.

FIG. 6 shows PLC output with single tone input for a long period of data loss.

FIG. 7 shows PLC output with speech input for a short period of data loss.

FIG. 8 shows PLC output with a speech input for a long period of data loss.

### DETAILED DESCRIPTION OF THE INVENTION

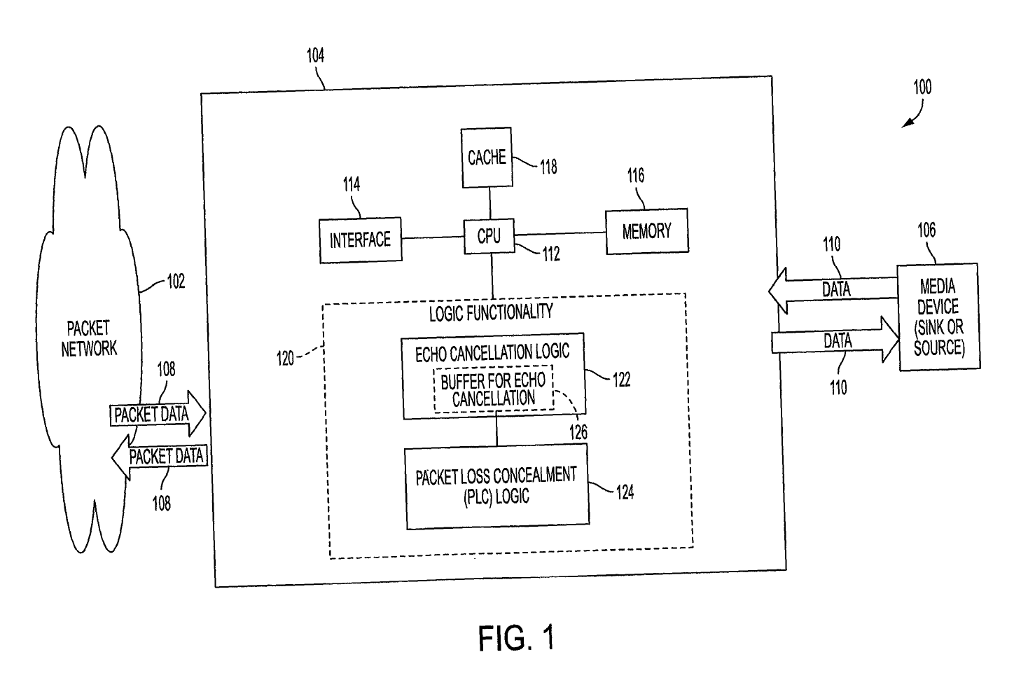

FIG. 1 shows an overview of one exemplary system 100 for implementing the present invention. The system 100 includes a packet network 102 which may be any type of packet network, for example wireless, cellular, ATM, etc. In one exemplary embodiment, the packet network 102 comprises a network governed by the IP/TCP protocol, such as the Internet, or an intranet. The network may include any type of physical links, such as fiber-based links, wireless links, copper-based links, etc. By way of example and not limitation, the network 102 may operate using any type of network-enabled code, such as HyperText Markup Language (HTML), Dynamic HTML, Extensible Markup Language (XML), Media Gateway Control Protocol (MGCP), Session Description Protocol (SDP), Broadband Loop Emulation Services (BLES), Extensible Stylesheet Language (XSL), Document Style Semantics and Specification Language (DSSSL), Cascading Style Sheets (CSS), etc.

Packet data 108 may be transmitted over the network 102 using any type of format. Packet data may include audio samples and/or audio data. By way of example and not limitation, Real Time Protocol (RTP) provides one exemplary technique for transmitting audio data over the network. This technique appends an RTP header to each payload of audio data. The header provides various information concerning the data and the communication session. The combination of the RTP header and the audio payload forms an RTP packet. In one manner, the technique may encapsulate the RTP packet as a UDP packet, for example, and transmit this packet over the packet network. However, it should be noted that the invention is not limited to the use of RTP to transmit audio information over the packet network. Further, the application of the invention is not limited to a specific transport layer, could be, for example ATM rather than UDP, and does not have to be a transport layer, e.g., could be a session layer, serial-link layer, etc.

A processing device 104 may transmit and/or receive the packet data 108, which may include audio samples and/or audio data. In one embodiment, for instance, the processing device 104 comprises a conventional digital signal processing (DSP) device. Generally speaking, the processing device 104 may include conventional DSP processing components, such as a processor 112 (such as a microprocessor), memory 116, cache 118, and communication interface 114. The processor 112 serves as a central engine for executing machine instructions. The memory 116 (such as a Random Access Memory, or RAM) and cache 118 serve the conventional role of storing program code and other information for use by the processor 112. The communication interface 114 serves the conventional role of interacting with external equipment, such as the packet network 102.

The processing device 104 also interacts with media device 106. The media device 106 receives audio information 110 from the packet network 102 via the processing device 104 for output to a user. The media device 106 may also generate audio information 110 for transmission to the packet network 102 via the processing device 104. The media device 106 may comprise any type of unit, such as a telephone handset, speaker phone, audio recording device, etc.

The processing device 104 also includes logic functionality 120 for executing various processing tasks with respect to the data packets containing audio information. This logic functionality 120 may be implemented as software stored in memory 116 (or in some other memory, not shown).

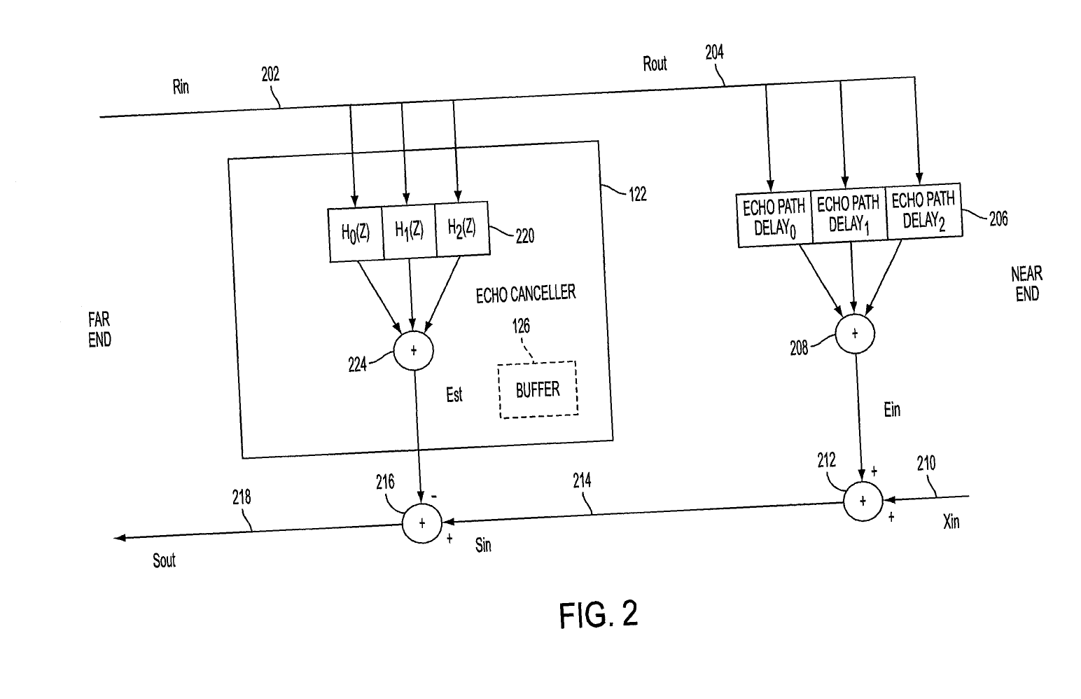

The logic functionality 120 may include an echo cancellation module 122 for canceling echoes created in the transmission of audio information. That is, in one instance, a “far end” user (not shown) may transmit audio information over the packet network 102 for receipt by the processing device 104, which constitutes the “near end.” A signal generated by the near end may also include a component attributed to the far end audio signal, constituting an unwanted audio signal. The echo cancellation module 122 removes this unwanted audio signal (in the manner to be described below in greater detail in the context of FIG. 2).

The echo cancellation module 122 includes a buffer 126 for storing received audio samples (e.g., packet data containing audio information). That is, the buffer 126 stores a prescribed segment of the most-recently received audio information. To facilitate extraction of information from this buffer 126, the echo cancellation module 122 may employ a pointer (not shown) to identify appropriate time positions within the buffer 126. As will be described in further detail below, the echo cancellation module 122 models an echo path impulse response based on the information stored in this buffer 126, which it uses to extract the actual echo from the audio information.

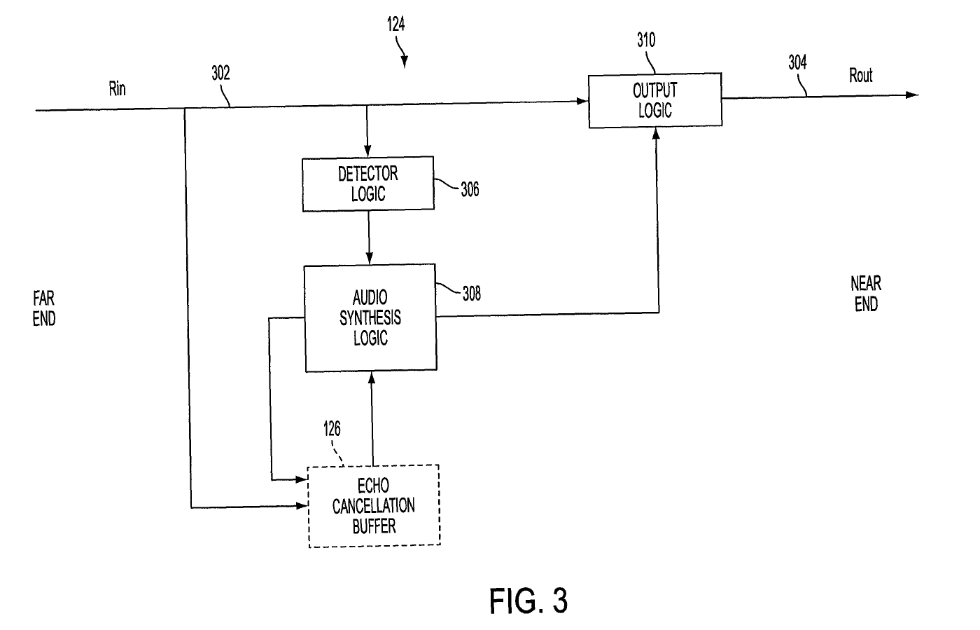

The logic functionality 120 also includes a packet loss concealment module 124. This module 124 detects whether the received audio samples contains lost packets (e.g., loss of audio samples). If there is packet loss, the module 124 conceals (or otherwise compensates for) the loss of the packets. By way of overview, the module 124 uses prior (i.e., historical) audio information that has been received by the processing device 104 in synthesizing replacement data for the loss packets. FIG. 3, to be discussed in further detail below, provides additional details regarding the packet loss concealment module 124.

According to a particularly beneficial aspect of the invention, the packet loss concealment module 124 retrieves the prior received audio information from the echo cancellation module's buffer 126. Hence, this buffer 126 provides historical data for use by both the echo cancellation module 122 and the packet loss concealment module 124. The use of one data buffer (instead of separate buffers for modules 122 and 124) provides a resource-efficient solution, allowing the present solution to be implemented in a cost-effective and size-efficient manner.

As mentioned above, FIG. 2 provides additional detail regarding exemplary functionality employed by the echo cancellation module 122. In operation, an input signal Rᵢₙ is received from a far end user via the packet network 102. The processing device 104 processes this signal and generates an output signal Rout to the media device 106. The processing device 104 may also receive an input signal Xᵢₙ from the media device 106 to be sent to the far end user. As understood in the art, echoes (Eᵢₙ) of the received signal Rout may sometimes combine with the signal Xᵢₙ to generate a signal Sin containing both desired signal (Xᵢₙ) and undesirable signal (Eᵢₙ).

More specifically, the echo path delay elements 206 represents the generation of echo components. Impedance mismatch in a hybrid element (not shown) used to couple a 2-wire circuit to a 4-wire circuit may constitute the most significant source of echo. The summation element 208 represents the summation of the echo components to generate the signal Eᵢₙ. The summation element 212 represents the combination of signal Ein with the input signal Xᵢₙ to produce the resultant signal Sᵢₙ. The presence of this echo signal in the audio information passed back to the far end user generates a distracting artifact that may impede communication between the far end user and the near end user.

To remove the unwanted echo signal, the echo cancellation module 122 generates a replica (Est) of the received signal (Rᵢₙ). The summation unit 216 then subtracts the replica Est from the signal Sin to generate an output signal (Sout) with echoes removed therefrom.

The echo cancellation module may use various types of algorithms to generate the replica of the received signal. In one case, the cancellation module estimates the echo delay and models the echo path impulse response with multiple FIR filters 220. More, specifically, in one embodiment, the signals Sout and Est(n) are defined by the following equations:

$$\begin{matrix}Sout ( n ) = Sin ( n ) - Eest ( n ) \\ Eest ( n ) = {\sum }_{j = 0}^{M - 1} {\sum }_{k = 0}^{{N}_{j} - 1} {h}_{j} ( k ) Rin ( n - {D}_{j} - k )\end{matrix}$$

Eest:estimated echo

M:number of reflectors

hⱼ:coefficients

Dⱼ:estimated delay

Nⱼ:number of coefficients

As mentioned above, the buffer 126 stores a portion of previously received audio information for use in modeling the echo path impulse response. The echo cancellation module 122 may use a pointer (not shown) to keep track of an appropriate location (or locations) within the buffer.

FIG. 3 shows an exemplary implementation of the packet loss compensation (PLC) module 124. In this configuration, detector logic 306 determines whether the input signal Ri, includes missing packets. A number of different techniques may be used to detect the loss of data. In one example, the detector logic 306 monitors sequence numbers or timestamp information included in the received packets' headers. The loss of packets may be determined by examining discontinuance in the stream of receive sequence numbers and/or timestamps. The detector logic 306 may also detect the resumption of received data packets after a period of loss, and provide appropriate signaling to designate this event.

Audio synthesis logic 308 performs processing to conceal (or otherwise compensate for) the loss of audio samples. Output logic 310 receives the output of the audio synthesis logic 308. In the absence of packet loss, the output logic 310 forwards the unaltered signal Rin to the near end user. If there is packet loss, the output logic 310 receives and outputs the synthesized audio generated by the audio synthesis logic 308.

FIG. 3 shows the echo cancellation buffer 126 in dashed lines to indicate that this unit is associated with the echo cancellation module 122 (shown in FIG. 2), and not the PLC module. The echo cancellation buffer 126 stores a portion of the most recently received audio information from signal Rin. In the event of packet loss, the audio synthesis logic 308 pulls this prior audio information from the buffer and uses it to “patch” the missing data. In this case, the audio synthesis logic 308 also forwards its synthesized output to the buffer 126 for storage therein.

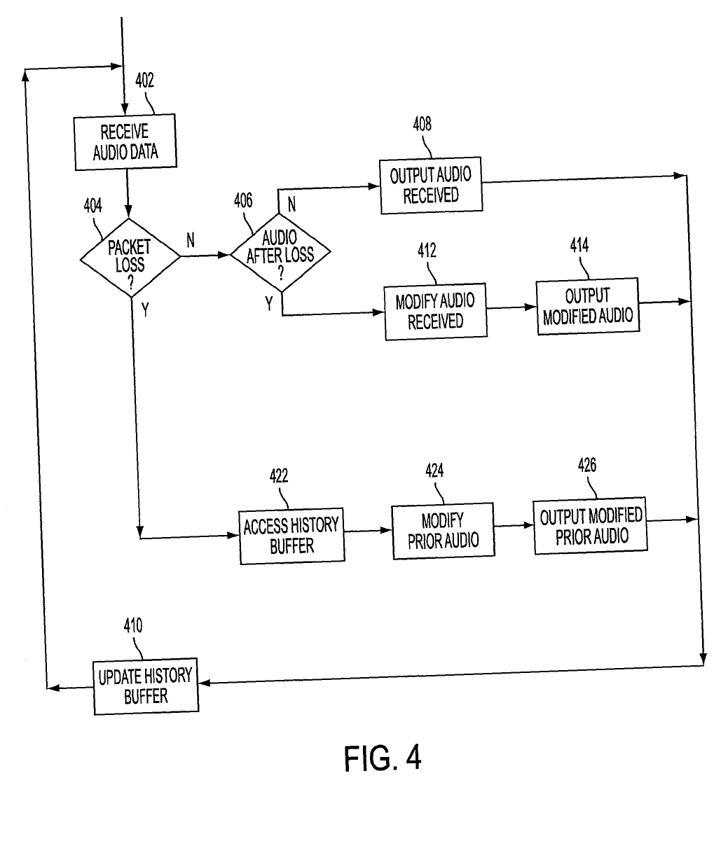

FIG. 4 illustrates an exemplary processing routine for performing packet loss concealment. In step 402, the PLC module 124 receives packet data, such as audio samples or audio data. In step 404, the PLC module determines whether a packet loss has occurred using one or more of the techniques described above, or some other technique. In step 406, if no packet loss is occurred, the PLC module determines whether the prior packet (or packets) were lost (and thus may have been synthesized by the PLC module 124). If this is not the case, the PLC module 124 processes and outputs the audio data according to the normal course of operation of the processing device. Then, in step 410, the processing device 104 stores the output data to the echo buffer 126, to thereby provide the most recent historical Rin data to the buffer 126.

In step 422, if packet loss has occurred, the PLC module 124 accesses the buffer 126 and retrieves information stored therein. More specifically, the PLC module 124 may access a most-recently received segment of data. The buffer's pointer may be used to designate the start of this segment of data. Then, in step 424, the PLC module 124 modifies the stored prior audio data by attenuating it. More specifically, in one embodiment, the PLC module 124 detects the power of a received portion of the stored audio data. If the power of the portion of the audio data is above a prescribed threshold, then the PLC module 124 attenuates the audio data by a prescribed decibel level. If the power of the portion of the audio data is below (or equal to) the prescribed threshold, then the PLC module leaves the stored data unaltered, because it already constitutes the functional equivalent of silence. In step 426, the PLC module 124 outputs the prior audio data. In step 410, the processing device 104 also stores the output audio data in the echo buffer 126.

The PLC module 124 may be configured to attenuate the stored data using various techniques. In one technique, the PLC module 124 modifies a portion of recently received audio information by a specified downward-sloping attenuation function. The function may be designed to attenuate the stored data in an logarithmic fashion, a linear fashion, or through the use of a Hamming window (or some other type of function). The attenuation of prior stored audio data is desirable to prevent the generation of unnatural sounding artifacts, such as beeps or hisses. At the same time, this attenuation is gradual, so as not to create the distracting occurrence of cracks and pops (e.g., caused by the immediate transition to silence levels). For short periods of packet loss, the use of historical audio information obtained from buffer 126 may provide an imperceptible extension of the speaker's voice.

In an alternative embodiment, the PLC module 124 may output information stored in the echo cancellation module buffer 126 without attenuating this information for an initial period of data loss. After this the initial period of data loss, the PLC module 124 may then begin attenuating the stored data.

In an alternative embodiment, the PLC module may provide additional signal processing techniques to ensure a more gradual transition from actual received packet data (e.g., audio samples, audio data) to synthesized packet data (and then back again from synthesized data to actual received data). For instance, the PLC module 124 may provide interpolating techniques to reduce any discontinuity between the actual received data and the synthesized data. Further, the PLC module 124 may determine the pitch of the speaker's voice from the stored data and generate a synthesized signal which matches this pitch for one or more pitch periods. These techniques are described, for instance, in “Packet Loss Concealment for Use with ITU-T Recommendation G.711,” by American National Standards Institute, Document number T1.521-1999, which is incorporated herein by reference in its entirety. However, these supplemental techniques are not required, and a designer may well want to eliminate these techniques to provide a more resource-efficient, and/or cost-effective solution.

In yet another alternative embodiment, when the power level of the stored data drops below a prescribed level, the PLC module 124 may output a signal produced by a white noise generator (instead of outputting the signal in unaltered form). This may be considered desirable to provide “comfort noise” during periods of significant packet loss.

Continuing with the discussion of FIG. 4, when audio data is received, in step 406, the PLC module 124 determines whether such data was preceded by a period of data loss. If so, in step 412, the PLC module modifies the received audio data to smooth the transition from the period of data loss to resumption of receipt of data. This operation may comprise multiplying the received audio data by an upward-sloping attenuation function (such as an logarithmic function, a linear ramp function, or some other function). More specifically, the PLC module 124 may attenuate the received audio data by an amount of decibels. This amount decreases over time until it becomes zero. In this fashion, subsequent to a loss of data, the volume of the received signal increases from zero to normal volume in a gradual fashion. This again helps reduce the occurrence of unnatural pops and cracks in the received input signal. In step 410, the PLC module stores the modified audio data in the buffer 126.

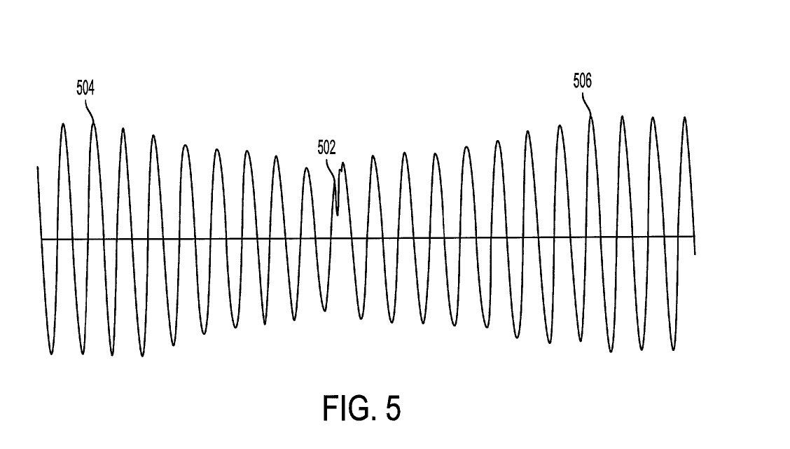

FIGS. 5-8 illustrate the exemplary performance of the PLC module 124. More specifically, FIG. 5 shows PLC output with single tone input for a relatively short period of data loss. In this exemplary case, the PLC module 124 initially detects the loss of data at time position 504. The PLC module 124 then accesses information from the echo cancellation module's buffer 126, attenuates this data based on a downward-sloping attenuation function, and the then outputs the attenuated data. At approximately time position 502, the PLC module 124 detects the resumption of receipt of audio data. The PLC module 124 then begins attenuating the received data by an upward-sloping attenuation function. At time position 506, the received signal is being output at its intended full volume level. There is a small discontinuity at time position 502 where the synthesized data obtained from the buffer 126 is spliced into the subsequently received audio information.

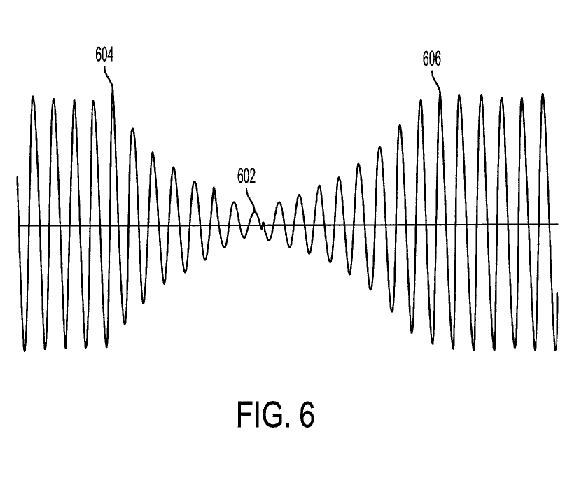

FIG. 6 shows PLC output with single tone input for a longer period of data loss. The waveform shown in FIG. 6 has the same general characteristics as the waveform shown in FIG. 5. Namely, time position 604 corresponds to the commencement of data loss. Time position 602 corresponds to the resumption of the receipt of data. Time position 606 designates the termination of the upward-sloping attenuation of the received data. However, in FIG. 6, the period of data loss is greater compared to FIG. 5, and hence the attenuation of the data is more pronounced. However, in the exemplary case of FIG. 6, the period of data loss is not so long as to reduce the output signal to silence levels.

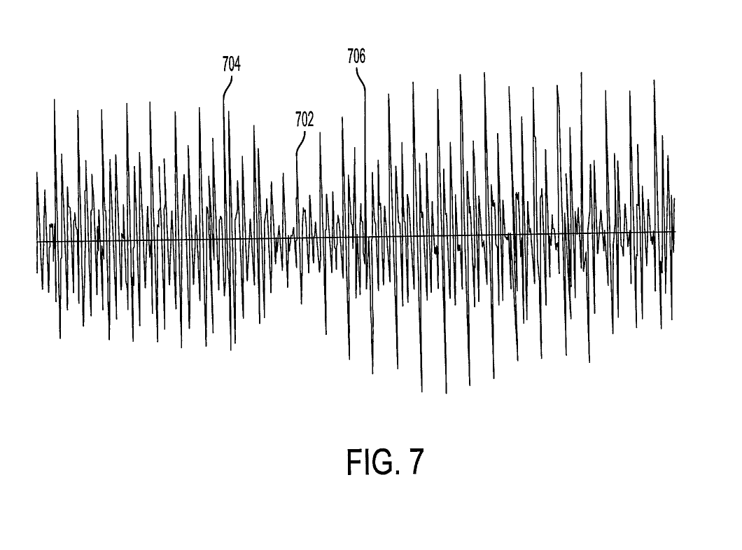

FIG. 7 shows PLC output with speech input for a short period of data loss. This figure has the same basic characteristics as FIG. 5, but for the case of actual speech input (as opposed to FIG. 5's illustration of single tone input). Time position 704 generally corresponds to the commencement of data loss. Time position 702 generally corresponds to the resumption of the receipt of data. Time position 706 generally corresponds to the termination of the upward-sloping attenuation of the received data. Because the period of data loss is minimal, the listener may be unaware of the substitution of synthesized data generated by the PLC module 124.

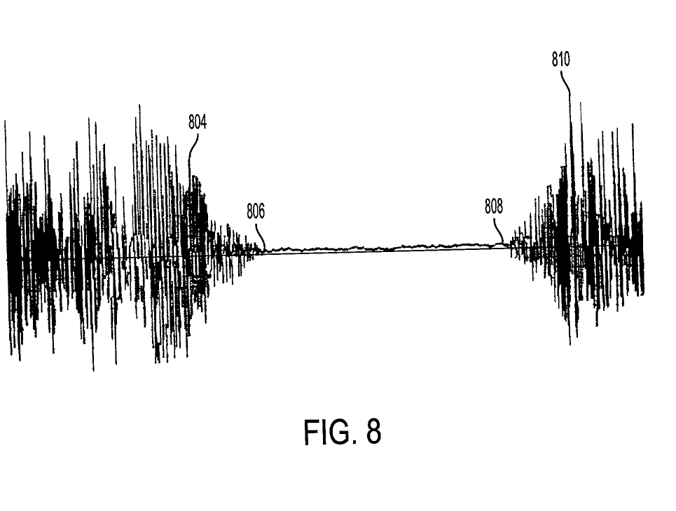

Finally, FIG. 8 shows PLC output with a speech input for a long period of data loss. Time position 804 generally corresponds to the commencement of data loss. At this point, the PLC module 124 begins to output stored data obtained from buffer 126, attenuated by a downward-sloping attenuation function. Time position 806 corresponds to the point at which the attenuation function has reduced the stored data to a level approximating a silence level. This silence level continues until time position 808, which generally corresponds to the resumption of the receipt of data. Time position 810 generally corresponds to the termination of the upward-sloping attenuation of the received data. Because the period of data loss is significant in this case, the listener will likely be aware of the drop in audio levels. However, this loss is gradual, thereby reducing some of the disturbing effects of such loss.

In the above discussion, the PLC module was described as using the buffer employed by the echo cancellation module. In more general terms, the echo cancellation module and the PLC module make use of the same buffer which may be primarily associated with either the echo cancellation module or the PLC module. In still other embodiments, the processing device may be designed in such a manner that the single buffer is not primarily associated with either module, but is provided at some intermediate location designed to serve both modules. Accordingly, use the term echo cancellation buffer in the ensuing claims merely represents that the buffer serves an echo cancellation module, and is not intended to convey whether the buffer is physically associated with (or was initially intended or designed to serve) the echo cancellation module or the PLC module, or some other module.

Other modifications to the embodiments described above can be made without departing from the spirit and scope of the invention, as is intended to be encompassed by the following claims and their legal equivalents.

What is claimed is:

1. An apparatus for concealing a loss of at least one audio sample sent within a packet data network, comprising:
an echo cancellation module buffer for storing at least one received audio sample;
logic for buffering the received audio sample in the echo cancellation module buffer;
logic for detecting the presence of a loss of audio sample;
logic for concealing the loss of audio sample based on the audio sample stored in the echo cancellation module buffer and for generating a concealed output based thereon; and
logic for outputting data based on the concealed output.

2. The apparatus of claim 1, wherein the logic for concealing comprises:
logic for attenuating the audio sample stored in the echo cancellation module buffer based on an attenuation function.

3. The apparatus of claim 2, wherein the attenuation function attenuates the audio sample stored in the echo cancellation module buffer in logarithmic fashion.

4. The apparatus of claim 2, wherein the attenuation logic is configured to modify the audio sample stored in the echo cancellation module buffer by the attenuation function only if the power of the audio sample stored in the echo cancellation module buffer is above a prescribed threshold.

5. The apparatus of claim 1, further including:
logic for detecting receipt of packet data after a packet loss; and
logic for attenuating the audio sample received after a packet loss an attenuation function.

6. An apparatus for processing at least one audio sample sent within a packet data network, comprising:
an echo cancellation module for canceling an echo within an audio sample received from a media device, comprising:
an echo cancellation module buffer for storing at least one received audio sample;
logic for buffering the received audio sample in the echo cancellation module buffer;
logic for generating a replica of the received audio sample;
logic for subtracting the replica from an input signal to remove any echo component contained therein;
a packet loss concealment module for concealing a loss of audio sample, comprising:
logic for detecting the presence of a loss of audio sample;
logic for concealing the loss of audio sample based on the audio sample stored in the echo cancellation module buffer and for generating concealed output based thereon; and
logic for outputting data based on the concealed output.

7. The apparatus of claim 6, wherein the logic for concealing comprises:
logic for attenuating the audio sample stored in the echo cancellation module buffer based on an attenuation function.

8. The apparatus of claim 7, wherein the attenuation function attenuates the audio sample stored in the echo cancellation module buffer in logarithmic fashion.

9. The apparatus of claim 7, wherein the attenuation logic is configured to modify the audio sample stored in the echo cancellation module buffer by the attenuation function only if the power of the audio sample stored in the echo cancellation module buffer is above a prescribed threshold.

10. The apparatus of claim 6, wherein the packet loss concealment module further includes:
logic for detecting receipt of packet data after a packet loss; and
logic for attenuating the audio sample received after a packet loss by an attenuation function.

11. A method for concealing loss of audio sample sent within a packet data network, comprising the steps of:
buffering at least one received audio sample in a echo cancellation module buffer;
detecting the presence of a loss of audio sample;
concealing the loss of audio sample based on the audio sample stored in the echo cancellation module buffer and for generating an output based thereon; and
outputting data based on the output of the concealing step.

12. The method of claim 11, wherein the step of concealing comprises the step of:
attenuating the audio sample stored in the echo cancellation module buffer based on an attenuation function.

13. The method of claim 12, wherein the attenuation function attenuates the audio sample stored in the echo cancellation module buffer in logarithmic fashion.

14. The method apparatus of claim 12, wherein the attenuating step modifies the audio sample stored in the echo cancellation module buffer by the attenuation function only if the power of the audio sample stored in the echo cancellation module buffer is above a prescribed threshold.

15. The method of claim 11, further comprising the steps of:
detecting receipt of packet data after a packet loss; and
attenuating the audio sample received after a packet loss by an attenuation function.

16. A method for processing at least one audio sample, comprising:
in an echo canceling operation, performing the steps of:
buffering at least one received audio sample in a buffer used by an echo cancellation module;
generating a replica of the received audio sample;
subtracting the replica from an input signal to remove any echo component contained therein;
in a packet loss concealment operation, performing the steps of:
detecting the presence of a loss of audio sample;
concealing the loss of audio sample based on the audio sample stored in the echo cancellation module buffer and for output based thereon; and
outputting data based on the output of the step of concealing.

17. The method of claim 16, wherein the step of concealing further comprises the step of:
attenuating the audio sample stored in the echo cancellation module buffer based on an attenuation function.

18. The method of claim 17, wherein the attenuation function attenuates the audio sample stored in the echo cancellation module buffer in logarithmic fashion.

19. The method of claim 17, wherein the attenuating step further comprises the step of:
modifying the audio sample stored in the echo cancellation module buffer by the attenuation function only if the power of the audio sample stored in the echo cancellation module buffer is above a prescribed threshold.

20. The method of claim 16, further comprising the steps of:
detecting receipt of packet data after a packet loss; and
attenuating the audio sample received after a packet loss by an attenuation function.
